(19) United States
(12) Patent Application Publication
(10) Pub. No.: US 2024/0127304 A1
(43) Pub. Date: Apr. 18, 2024

(54) SMART EDGE APPLICATION

(71) Applicant: DAVID SODEINDE, HAMPSTEAD, MD (US)

(72) Inventor: DAVID SODEINDE, HAMPSTEAD, MD (US)

(21) Appl. No.: 18/356,824

(22) Filed: Jul. 21, 2023

Related U.S. Application Data
(63) Continuation of application No. 63/395,109, filed on Aug. 4, 2022.

(51) Int. Cl. G06Q 30/0601; G06Q 10/083

(52) U.S. Cl. CPC G06Q 30/0609; G06Q 10/083; G06Q 30/0643

(57) ABSTRACT

Smart Edge, a patented e-commerce application, facilitates the purchase of new and used auto parts through an integrated platform. Sellers like Junkyards, individual sellers, and new parts dealers can list their inventories in real-time. The application accommodates buyers worldwide, allowing vehicle owners and mechanics to interact with sellers via instant messaging and video calls for verification. Additionally, it provides space for shipping companies to offer services to potential buyers. The application addresses the challenges of sourcing authentic auto parts and streamlines the purchasing process for mechanics and vehicle owners. It incorporates buyer and seller ratings, KYC, and shipping integration, ensuring prompt and reliable deliveries. By leveraging Smart Edge, users can easily find and purchase the right auto parts, revolutionizing the way automotive components are sourced and traded.

### FIELD OF THE INVENTION

The present invention relates to an e-commerce application and website that provides a user-friendly platform for mechanics and repair people to purchase automotive parts conveniently and efficiently. The invention aims to address the issues of substandard auto parts flooding the market and the time-consuming process of sourcing proper parts.

### Solution

The invention, known as “SmartEdge,” is a specialized web-based application that enables both private sellers and companies to list new and used auto parts. Buyers can easily communicate with sellers to negotiate prices and purchase parts. SmartEdge integrates shipping and tracking capabilities with delivery companies to ensure timely and reliable delivery of purchased parts. Moreover, the application facilitates communication between users through instant messaging and video calls for further verification.

### DETAILED DESCRIPTION OF THE INVENTION

SmartEdge is designed to cater to the needs of mechanics and repair people seeking reliable automotive parts. The application provides a user-friendly interface where sellers can list their auto parts, including used parts from car junkyards and new parts from dealers. Both domestic and international buyers can engage with sellers through real-time communication, making it possible for a mechanic in a distant location to visually inspect parts through video calls.

The application features buyer and seller ratings, promoting a trustworthy marketplace. Additionally, Know Your Customer (KYC) verification ensures secure transactions and helps prevent the purchase of substandard auto parts. By integrating shipping and tracking services, SmartEdge guarantees prompt delivery, enhancing customer satisfaction.

### DETAILED DESCRIPTION OF DRAWINGS

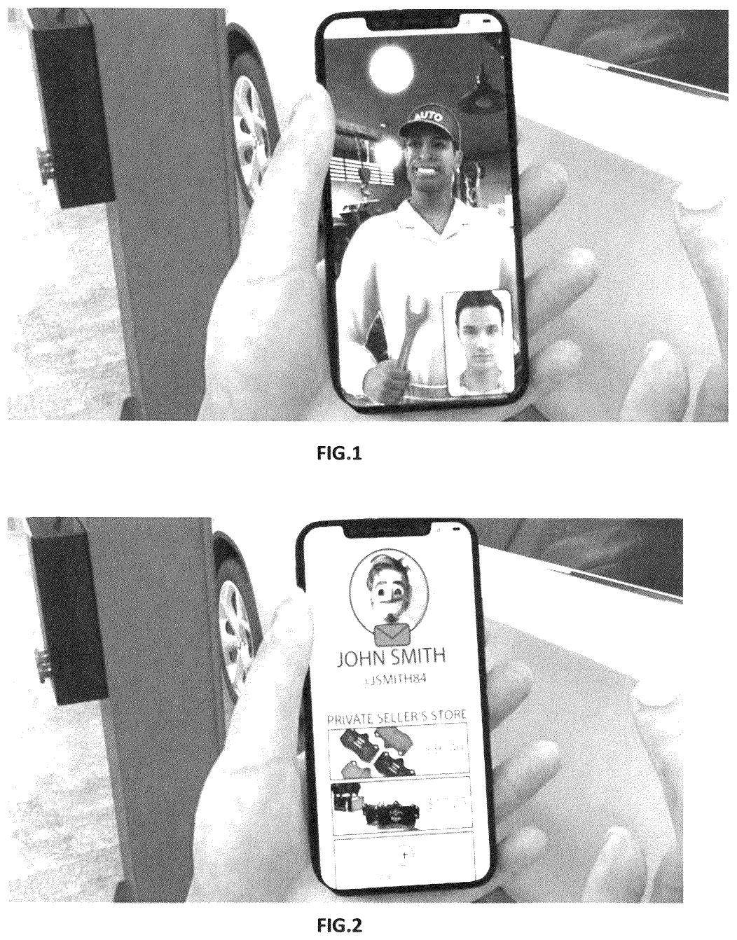

FIG. 1 illustrates a mechanic using the SmartEdge application while working on a vehicle, demonstrating the ease of access and multitasking capabilities.

FIG. 2 showcases various auto parts available for purchase on the platform.

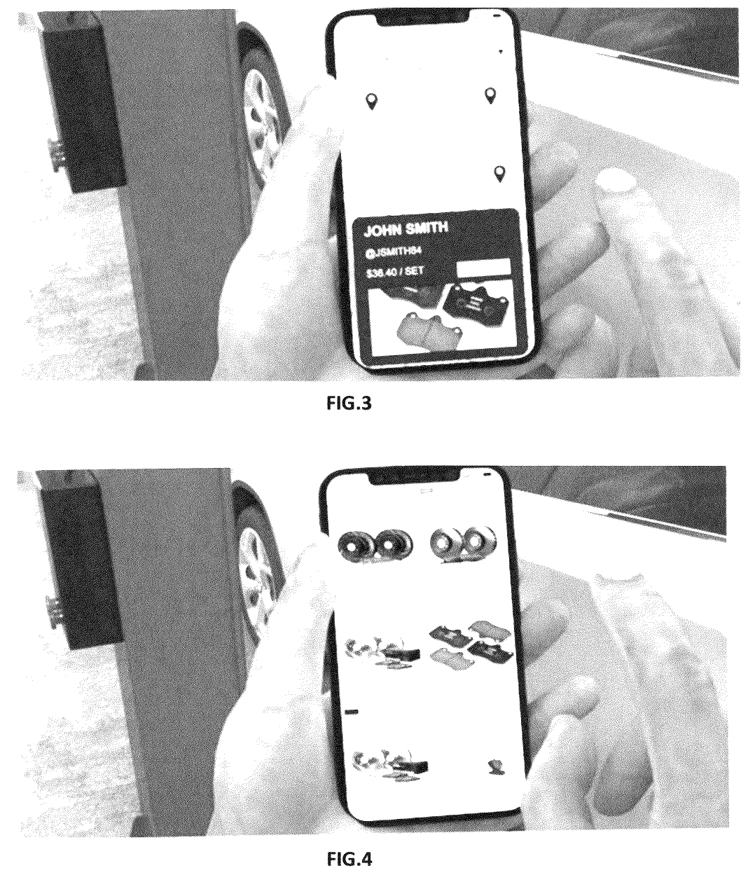

FIG. 3 demonstrates the application's functionality in locating specific auto parts efficiently.

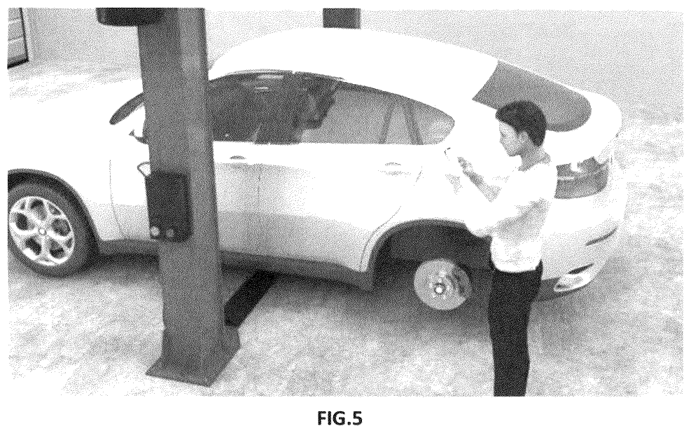

FIG. 4 displays a private seller's store within the application, showcasing the diversity of sellers available.

FIG. 5 depicts a seamless purchase process between two parties, highlighting the simplicity and effectiveness of SmartEdge.

### CONCLUSION

SmartEdge represents a novel e-commerce platform designed to streamline the purchase process for automotive parts. The application's features and integrated functionalities offer a comprehensive solution to the challenges faced by mechanics and repair people in sourcing reliable auto parts efficiently. The invention, through its unique features and advantages, provides a significant step forward in the automotive parts procurement industry.

1. A novel e-commerce application, named “Smart Edge,” comprising a user-friendly platform for the purchase of new and used auto parts, wherein the platform enables sellers, including Junkyards, individual sellers, used parts sellers, and new parts dealers, to list their inventories in real-time via API or registrations.

2. The e-commerce application of claim 1, further accommodating buyers from the United States and international markets, allowing vehicle owners and mechanics to engage with sellers through instant messaging and video calls, thereby enabling remote verification of auto parts before purchase.

3. An integrated system within the e-commerce application of claim 1, offering a space for various shippers and freight companies to provide services to potential buyers/sellers based on mutually agreed terms and conditions, with Smart Edge responsible for monitoring and ensuring adherence to shipping policies.

4. The e-commerce application of claim 1, providing a secure platform with buyer and seller ratings, KYC verification, and reliable transaction processing to prevent the flooding of substandard auto parts in the market.

5. An innovative integration of shipping and tracking capabilities with delivery companies in the e-commerce application of claim 1, ensuring prompt and efficient delivery of purchased auto parts to buyers.

6. The e-commerce application of claim 1, serving as a convenient and efficient solution for mechanics and residential buyers to easily source and purchase authentic auto parts, thus streamlining the procurement process and saving valuable time.

7. A specialized web-based application, as described in claim 1, facilitating seamless interactions between sellers of used auto parts, car junkyards, and new auto parts, and various buyers across the United States and beyond, thereby enhancing accessibility and convenience in the automotive spare parts industry.

8. The e-commerce application of claim 1, offering real-time inventory listings, instant messaging, video call features, and secure transactions, thereby addressing the challenges faced by mechanics and vehicle owners in sourcing and purchasing genuine auto parts efficiently.

9. An innovative and comprehensive e-commerce platform, as claimed in claim 1, providing a solution to efficiently connect buyers and sellers, including private sellers and companies, to negotiate and agree upon prices for purchasing auto parts.

10. The e-commerce application of claim 1, incorporating features to verify listed auto parts before purchase, preventing potential buyers from acquiring substandard parts, thus ensuring customer satisfaction and enhancing the overall quality of automotive maintenance and repairs.
